(19) United States
(12) Patent Application Publication
(10) Pub. No.: US 2026/0336940 A1
(43) Pub. Date: Oct. 29, 2026

(54) STAIR CONVEYOR AND METHOD FOR CONVEYING ROD-SHAPED MATERIAL

(71) Applicant: Rattunde AG, Ludwigslust (DE)

(72) Inventor: Leonhard RATTUNDE, Schwerin (DE)

(73) Assignee: Rattunde AG, Ludwigslust (DE)

(21) Appl. No.: 19/107,079

(22) PCT Filed: Sep. 29, 2023
(86) PCT No.: PCT/EP2023/077132

§ 371 Date: Feb. 27, 2025

(30) Foreign Application Priority Data
Oct. 7, 2022 (DE) 10 2022 125 994.3

(51) Int. Cl. B65G 25/08

(52) U.S. Cl. CPC B65G 25/08; B65G 2201/0276

(57) ABSTRACT

The invention relates to stair conveyors for bar-shaped materials (2) with a first stair with at least two first stair elements (5a, 5b, 5c) spaced apart from one another and a second stair movable up and down relative to the first stair between a lower position and an upper position with at least two second stair elements (6a, 6b, 6c) spaced apart from one another, wherein the first and second stair elements (5a, 5b, 5c) are arranged next to one another in a longitudinal direction (L) and lower first treads (51a, 51b, 6c) are arranged next to one another, 6b, 6c), wherein the first and second stair elements (5a, 5b, 5c) are arranged side by side in a longitudinal direction (L) and lower first treads (51a, 51b, 51c) of the first stair elements (5a, 5b, 5c) and lower second treads (61a, 61b, 61c) of the second stair elements (6a, 6b, 6c) co-form a lower tread in the lower position and upper first treads (52a, 52b, 52c) of the first stair elements (5a, 5b, 5c) form a lower tread in the upper position, 52b, 52c) of the first stair elements (5a, 5b, 5c) and the lower second treads (61a, 61b, 61c) of the second stair elements (6a, 6b, 6c) co-form an upper tread in the upper position, wherein the first stair elements (5a, 5b, 5c) are connected to one another by first rails (16a, 16b, 16c) at transition regions between first risers and treads, which form a first slipping edge extending in the longitudinal direction (L) for the bar-shaped materials (2) and/or the second stair elements (6a, 6b, 6c) are connected to one another at transition regions between second risers and treads by second rails (11a, 11b) which form a second slipping edge for the bar-shaped materials (2).

The invention relates to a stair conveyor according to the general term of claim 1. The invention also relates to a method for conveying bar-shaped materials.

In modern tube sawing systems, pre-materials, especially tubes, are processed in several steps. These are fed to the sawing systems and the tubes are cut to length with high precision and the ends of the tubes are processed, i.e. chamfered, washed, etc. The tubes must be fed to the sawing systems individually. The tubes have to be fed to the sawing machines in batches. The tubes are usually delivered in batches and loaded into a batch loading magazine. With the help of belts, which can be adjusted in length, a batch loading table is loaded with the tubes. For tubes with a small diameter, for example <10 mm, or tubes with low strength, for example aluminium, the so-called “spaghetti effect” occurs in the tube batch. This means that the tubes in the batch can be contorted, twisted or skewed and therefore cannot be lifted onto the batch loading table as part of the batch, and if they are, the pre-materials cannot be adequately separated there. This leads to disruptions in the process.

DE 10 2008 0595 07 B4 discloses a metalworking machine with a feeding device for bar-shaped workpieces. The pre-materials are separated from a batch loading magazine with the help of a stair conveyor.

The separation concept based on stair conveyors is based on the fact that stair elements are positioned at defined points along the pre-material. If the pre-material is twisted on the lower step, it is not picked up by all the stair elements when it is lifted to the next step. If the bending resistance of the pre-material is high enough, the increasing inclination of the pre-material causes it to be pulled down from the higher steps. After falling down, the pre-materials are positioned slightly differently and the conveying trial starts again. If the pre-material is conveyed evenly upwards by all conveying elements, the separation was successful. The disadvantage of this principle is that separation only takes place if the bending resistance is high enough. If the bending resistance is low, the pre-material is conveyed upwards on one side and not on the other and then assumes a stable position. It does not fall down, but also cannot be conveyed any further upwards and blocks other pre-materials from being conveyed upwards. In addition, this condition often leads to plastic deformation of the pre-material, which makes further processing in the machine impossible.

It is the object of the present invention to further develop a stair conveyor of the above-mentioned type which minimises the above-mentioned disadvantages.

Furthermore, it is the object of the present invention to provide a method for conveying bar-shaped materials which minimises the above-mentioned disadvantages.

The object is solved in its first aspect by a stair conveyor for bar-shaped materials with the features of claim 1.

The stair conveyor according to the invention has a first stair with at least two first stair elements spaced apart from one another and a second stair with at least two second stair elements spaced apart from one another and movable up and down relative to the first stair between a lower position and an upper position, wherein the first and second stair elements are arranged side by side in a longitudinal direction and lower first treads of the first stair elements and lower second treads of the second stair elements form a lower tread in the lower position and upper first treads of the first stair elements and the lower second treads of the second stair elements form an upper tread in the upper position. A step has a tread on which the bar-shaped materials are arranged during transport, and a riser which extends substantially and preferably perpendicularly to the treads and against which the bar-shaped materials strike and are prevented from rolling or sliding further.

The first stair is preferably stable in position relative to the ground or floor during operation. The second stair can be moved up and down. The terms “up” and “down” as well as “above and below” refer to the direction to the ground or floor.

The first stair elements are preferably arranged next to each other at a distance from each other in the longitudinal direction. The second stair elements are preferably arranged between preferably all of the first stair elements. The first and second stair elements have an extension in the longitudinal direction which is preferably less than 10%, preferably less than 5%, of the distance between two neighbouring stair elements.

The first stair elements at transition areas between first risers and treads are connected to one another by first rails which form a first slip-off edge running in the longitudinal direction for the bar-shaped materials and/or the second stair elements are connected to one another at transition areas between second risers and treads by second rails which form a second slip-off edge for the bar-shaped materials.

The rails facilitate the slipping of crookedly positioned bar-shaped materials onto one of the lower steps. Contorted, twisted, bent or crooked is summarised as crooked.

The first stair elements preferably have one, two, three or a higher number of steps. The second stair elements preferably have one, two, three or a higher number of steps, whereby the number of steps of the second stair elements is preferably one less than the number of steps of the first stair elements. Preferably, each first stair element is assigned exactly one second stair element and it runs up and down parallel to the assigned first stair element in the lifting movement.

In the lower position, lower first treads of the first stair elements and lower second treads of the second stair elements form a lower tread, they are aligned with each other, while in an upper position, the upper treads of the first stair form an upper tread with the lower treads of the second stair, they are also aligned. “Lower” and “upper” also refer to neighbouring steps. These can be the first, second, third or any higher steps.

The first and second stair elements are arranged next to each other in a longitudinal direction. They are preferably arranged alternately along the entire length of the stair conveyor.

The first stair elements of the first stair can be connected to each other with first rails at transition areas between their first risers and first treads. The first rails preferably extend over the entire longitudinal extent of the stair conveyor.

The second stair elements of the second stair can be connected to each other with second rails at transition areas between their second risers and second treads. The second rails preferably extend over the entire length of the stair conveyor.

The first and second rails can be rectangular or polygonal in cross-section. Preferably, they have a rolling edge that runs along their entire length. The cross-section can also be variable along the longitudinal direction. The same applies analogously to the second rails of the second stair elements.

The rails promote the unrolling of inclined bar-shaped materials. The first rails preferably promote the unrolling of inclined materials during a downward movement of the second stair elements, while the second rails preferably promote the unrolling of inclined pre-materials during the upward movement of the second stair elements. However, there are also interactions and the effects cannot always be clearly separated from each other.

The first and second rails are preferably continuous over the entire length of the stair conveyor, but they can also have different lengths or be partially interrupted.

The stair conveyor according to the invention is advantageously a component of a processing system for bar-shaped materials, which comprise an actual sawing system, a batch loading magazine and the stair conveyor according to the invention, in which the stair elements of the stair conveyor are preferably intermeshed with the belts of the batch loading magazine and the stair conveyor advantageously conveys the bar-shaped materials onto a batch loading table. From the batch loading table, the bar-shaped materials are then fed to the actual profile processing machine, for example the tube sawing machine or tube processing machine. The bar-shaped materials are preferably metal materials. They can be tubes, profiles or solid materials. The bar-shaped materials are preferably rollable, but this is not necessarily the case.

The stair conveyor for bar-shaped materials according to the invention has the first stair with at least two first stair elements and the second stair with at least two second stair elements, which can move back and forth relative to the first stair, wherein one stroke of the up and down movement preferably has the height of a riser. Preferably, the risers of the first and second stairs are all the same height.

This makes it possible for the bar-shaped materials to be lifted to the next higher step after a lift has been carried out, where they roll or slide to the stop of the next higher riser and therefore remain there when the second stair element is lowered and can be lifted to the next higher step with the next lift.

Ideally, the treads are inclined in the direction of the next higher riser to the ground.

Preferably, directly neighbouring transition areas of first stair elements are connected to each other by first rails and/or directly neighbouring transition areas of second stair elements are connected to each other by second rails.

Preferably, the neighbouring transition areas between second step elements are connected to the second rail and lower first steps each have a first indentation, the cross-section of which is larger than a cross-section of the second rail, such that the second rail disappears into the first indentation during a downward movement and forms a flat lower step in the lower position.

In the lower position, the second rails disappear into the lower tread and form rolling or sliding surfaces for the bar-shaped material.

Preferably, neighbouring transition areas between upper first stair elements are connected to the first rail and treads of lower second stair elements each have a second indentation, the cross-section of which is larger than a cross-section of the first rail, such that the first rail disappears into the second indentations during an upward movement and forms a flat upper tread in the upper position.

Here, a rolling or sliding surface for the bar-shaped material is formed in the upper position.

It is particularly preferable for the transition areas to have recesses through which a continuous rail that connects several stair elements is guided.

Preferably, the outer profile of the rails matches the outer shape of the first or second stair.

Second stair elements are particularly preferably each connected to a continuous drive shaft, which is connected to two drives and can be controlled by the drives in such a way that the drive shaft can be set in torsion.

In this embodiment, it is envisaged that the upward and downward movement of the individual second stair elements is not carried out in exactly the same way but in a staggered manner, such that the upward movement or downward movement begins in the same position. Over the duration of the upward or downward movement, the movements diverge, while in their end position, i.e. the upper or lower position, they are the same again.

Preferably, the drive shaft is connected to one of the second stair elements via a respective drive lever and the drive levers are connected to the drive shaft in a rotationally fixed manner, so that a torsion can be formed in the drive shaft by activating the two drives, so that the drive levers are rotated to different extents along the length of the drive shaft at a certain point in time and the second stair elements are raised or lowered to different extents at least temporarily.

The slight offset of the up and down movement of the second stair element has shown that inclined bar-shaped materials fall down more easily and are easier to transport during a second attempt at the upward movement.

The obect is fulfilled in its second aspect by a method with the features of claim 10.

The method according to the invention is suitable for implementation with one of the above-mentioned stair conveyors. Conversely, one of the methods described below can be carried out with any of the above-mentioned stair conveyors. By analogy, the embodiments of the stair conveyor also relate to the method and are deemed to be co-disclosed for the latter.

According to the invention, the bar-shaped materials are lifted from a lower step by moving the second step elements onto the upper step and bar-shaped materials slipping on one of the steps slide automatically over one of the slipping edges.

Preferably, sloping bar-shaped materials slide down the upper tread over the first sliding edge when the second step elements move downwards.

It is particularly preferable for sloping bar-shaped materials to slide down the lower tread when the second stair elements are moved upwards over the second slipping edge.

In a particularly preferred further development, the second stair elements are moved offset to each other during the relative movement. In particular, one drive and the other drive will start in the same position and one drive will run ahead of the other drive and in an end position the two drives will run in the same direction again.

The invention is described with reference to several embodiments in 26 figures. They show:

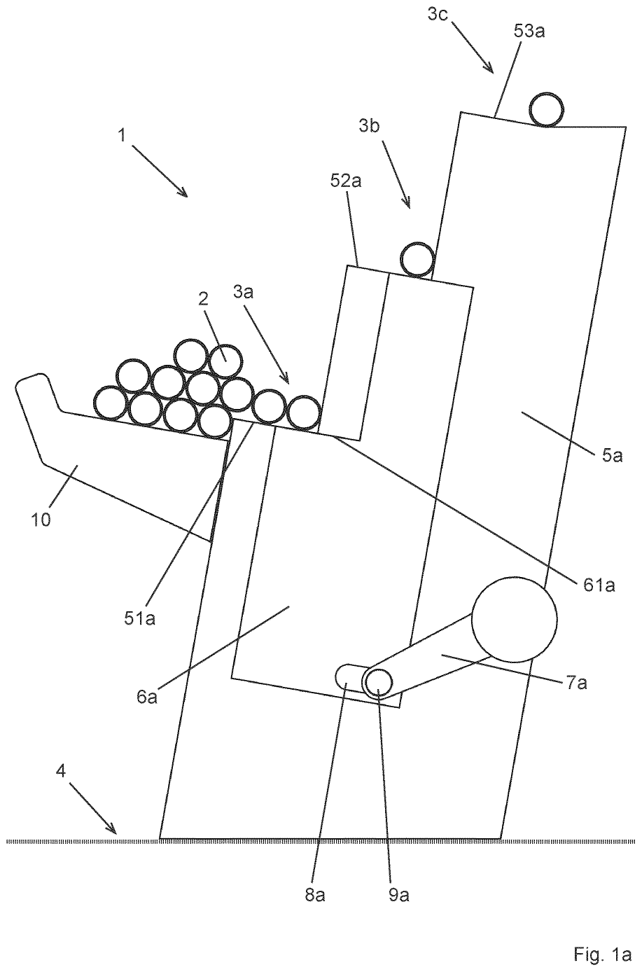

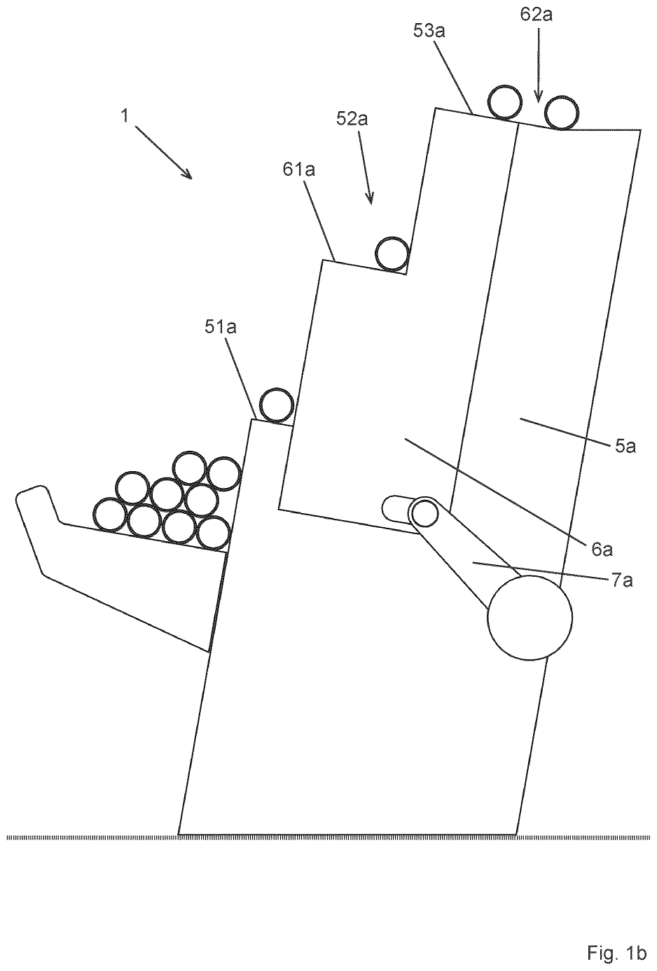

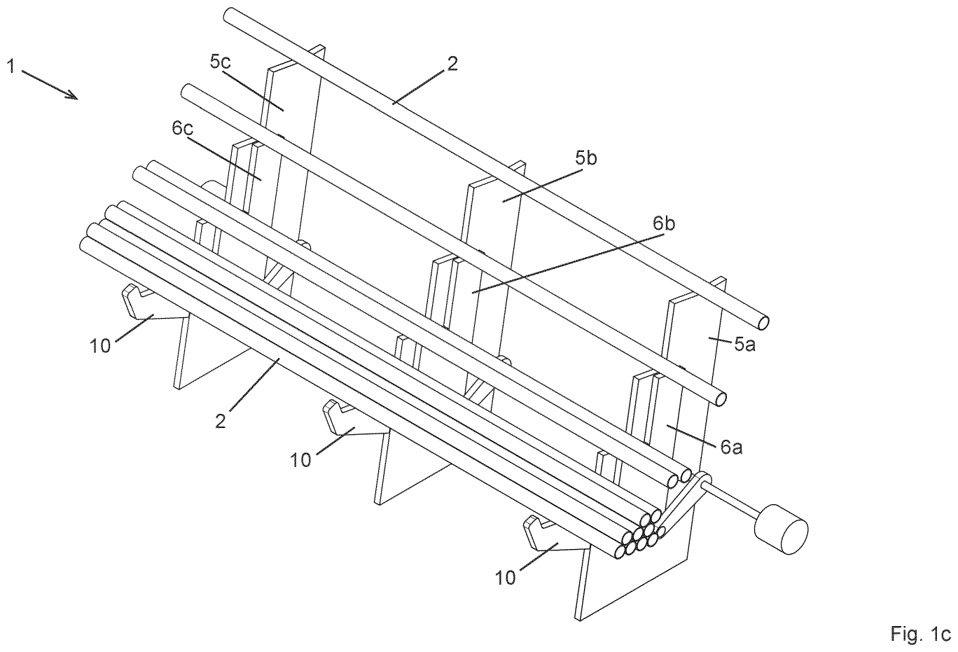

FIG. 1a A stair conveyor according to the state of the art in a lower position,

FIG. 1b the stair conveyor in FIG. 1 in an upper position,

FIG. 1c isometric view of the stair conveyor in FIG. 1 with tubes in place,

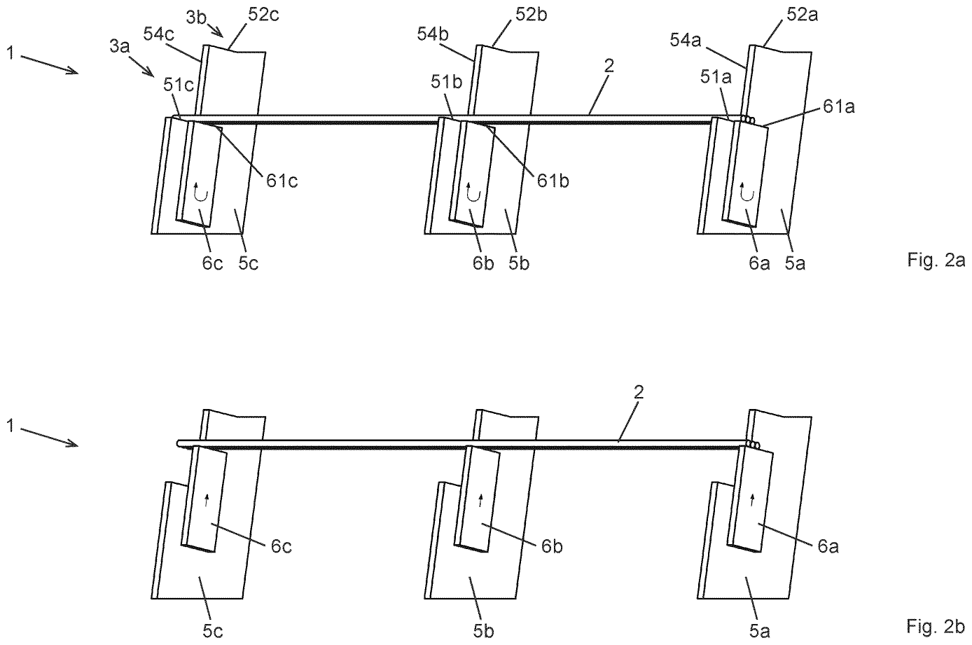

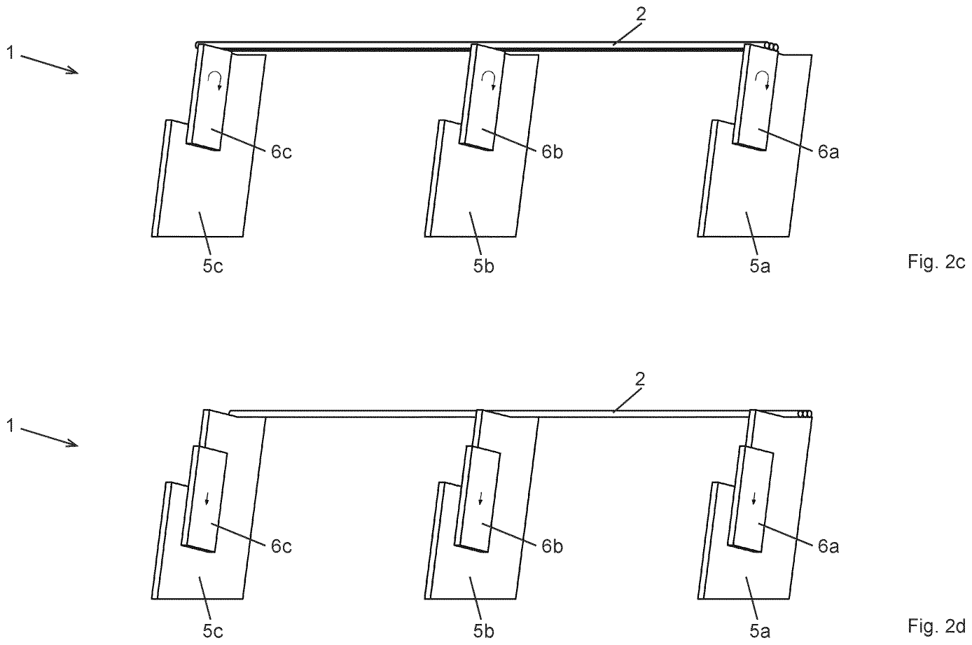

FIG. 2a-FIG. 2d principle mode of operation of a stair conveyor according to the state of the art of the art with two steps,

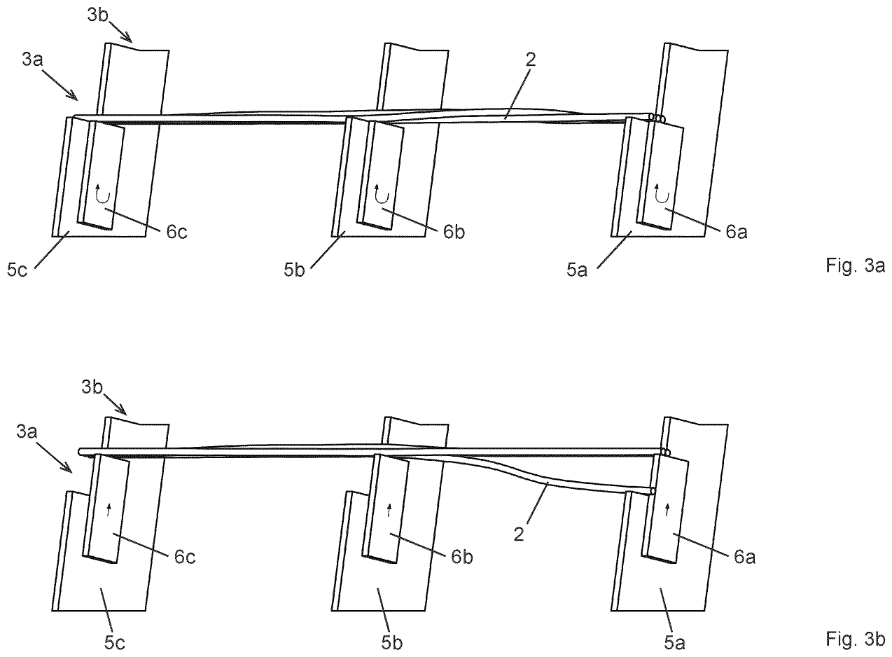

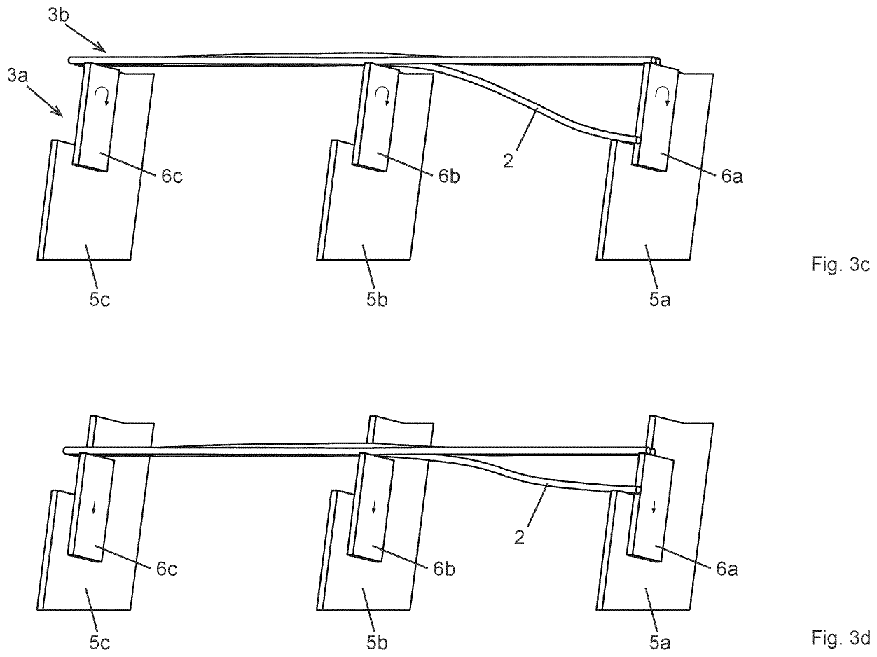

FIG. 3a-FIG. 3d diagram of an incomplete lifting of the tubes,

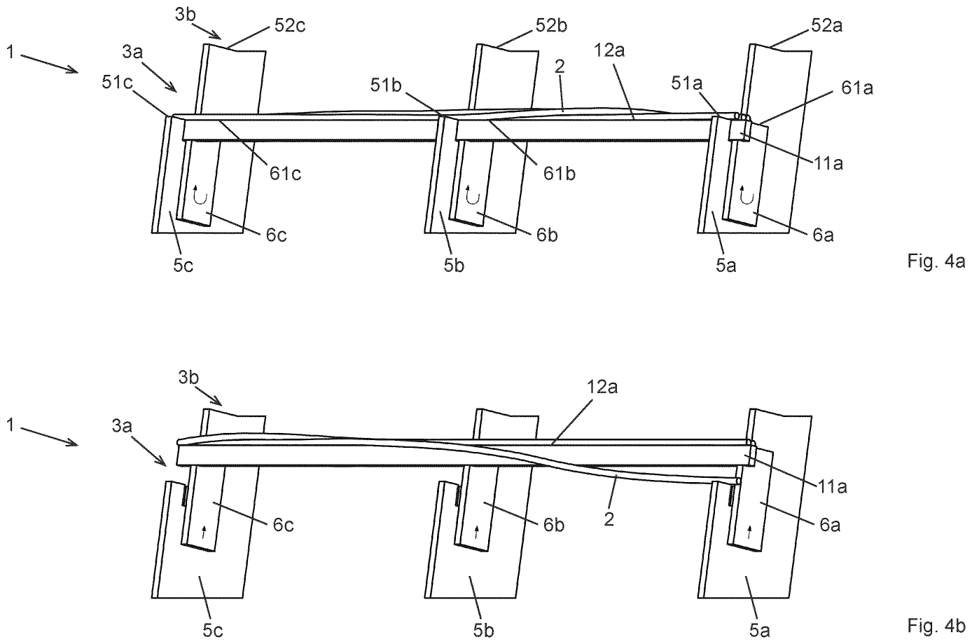

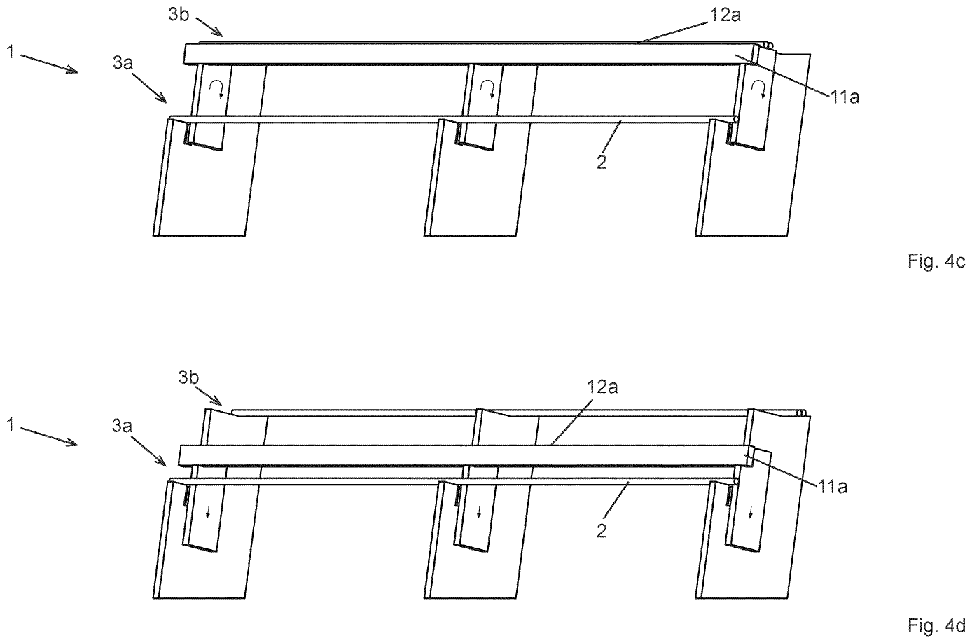

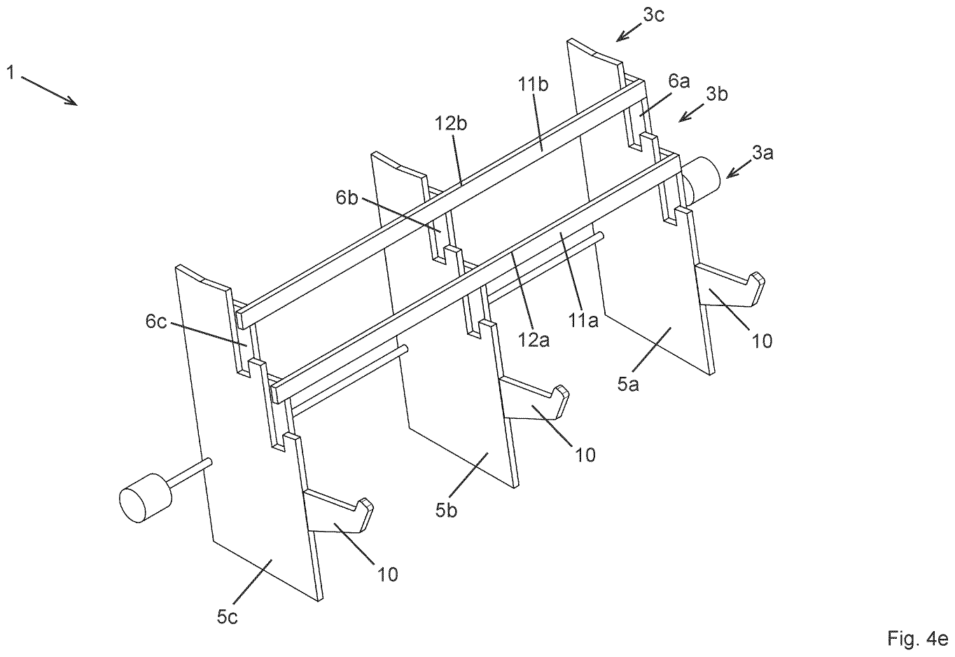

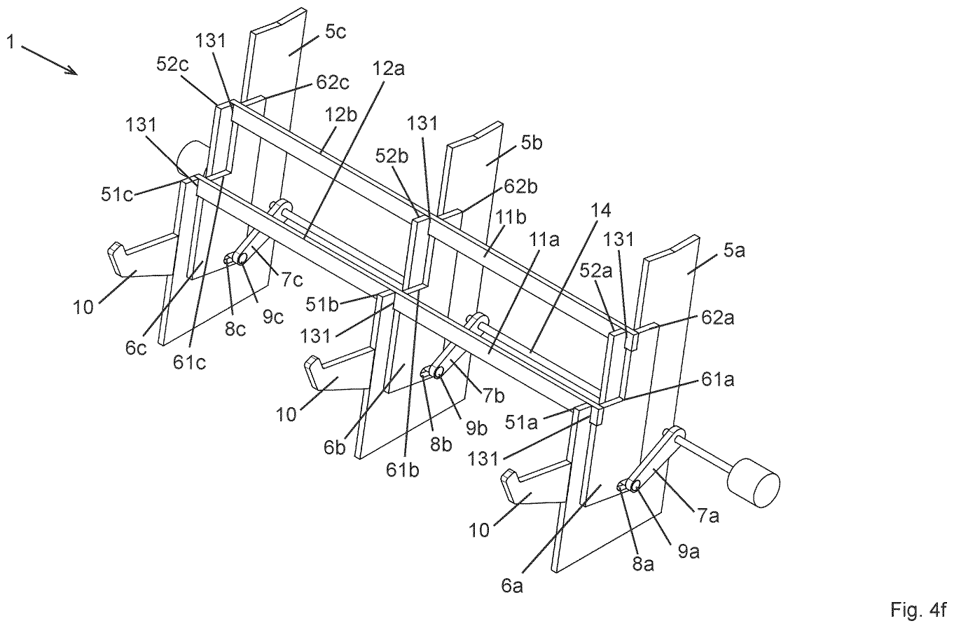

FIG. 4a-FIG. 4f Depiction of the mode of operation of a first stair conveyor according to the invention with second rails,

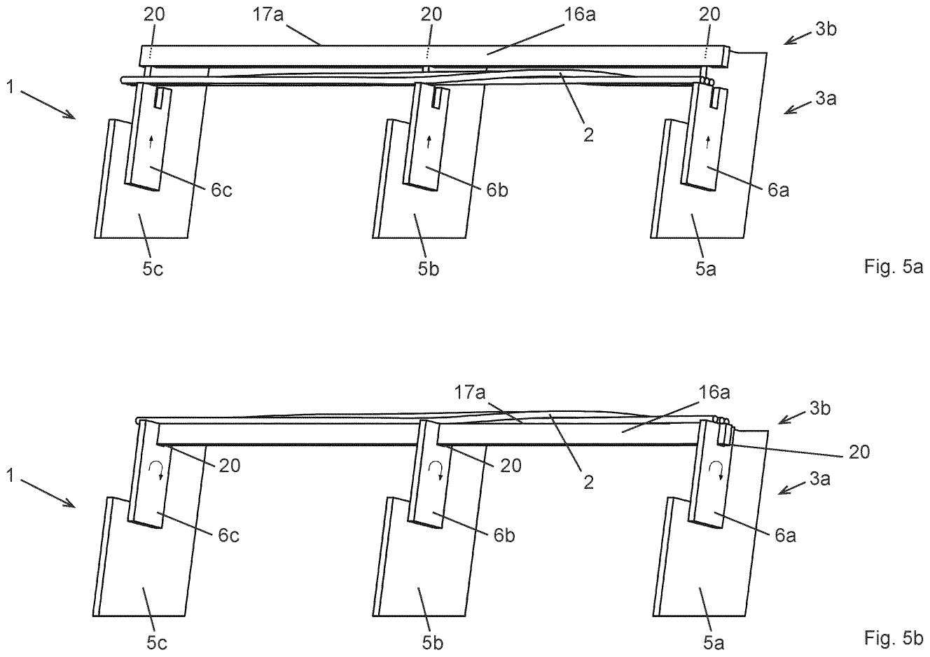

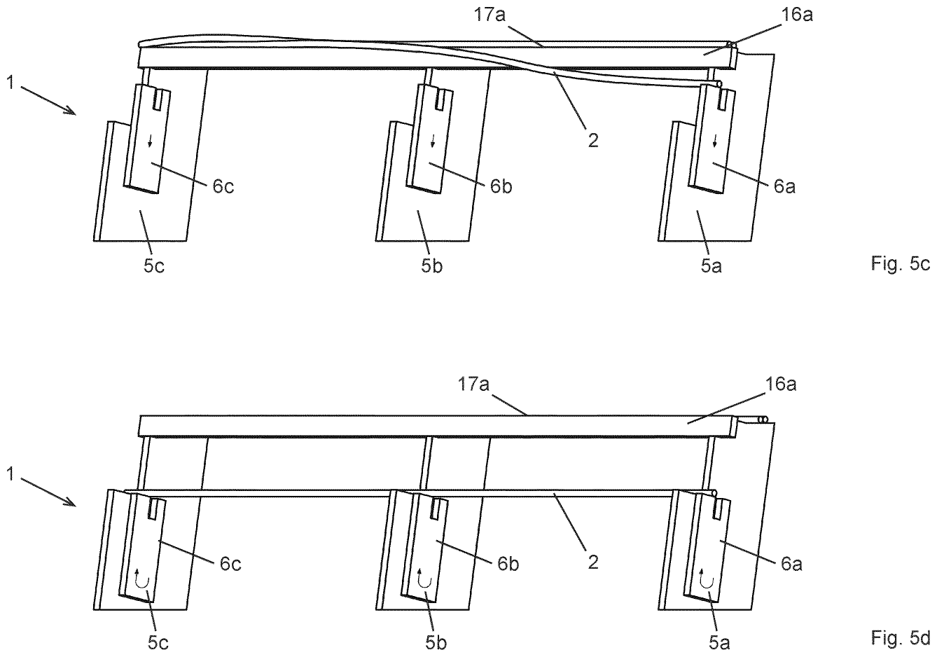

FIG. 5a-FIG. 5d Depiction of the mode of operation of a second stair conveyor according to the invention with first rails,

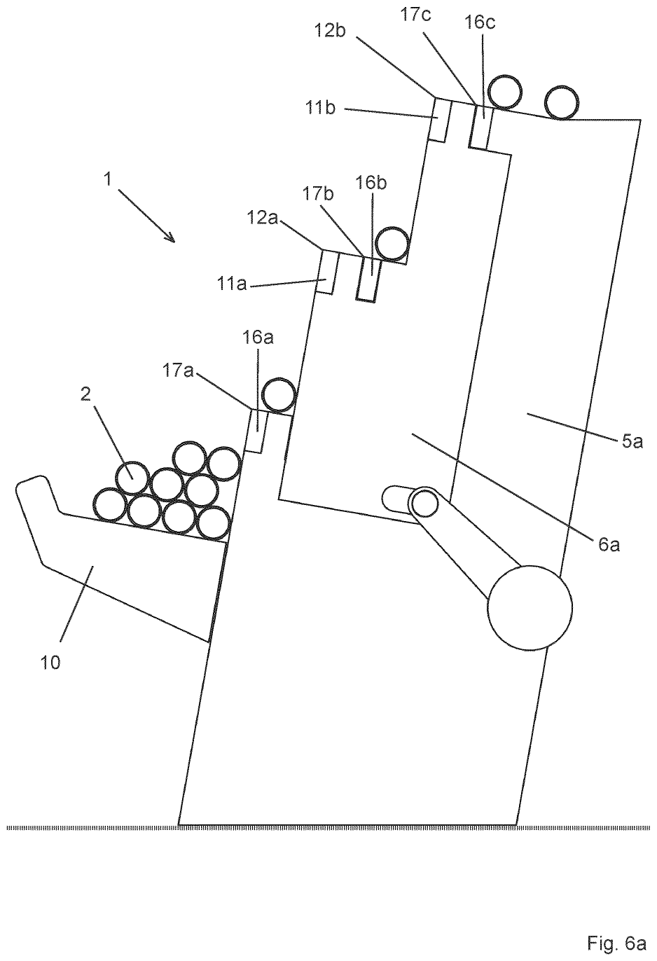

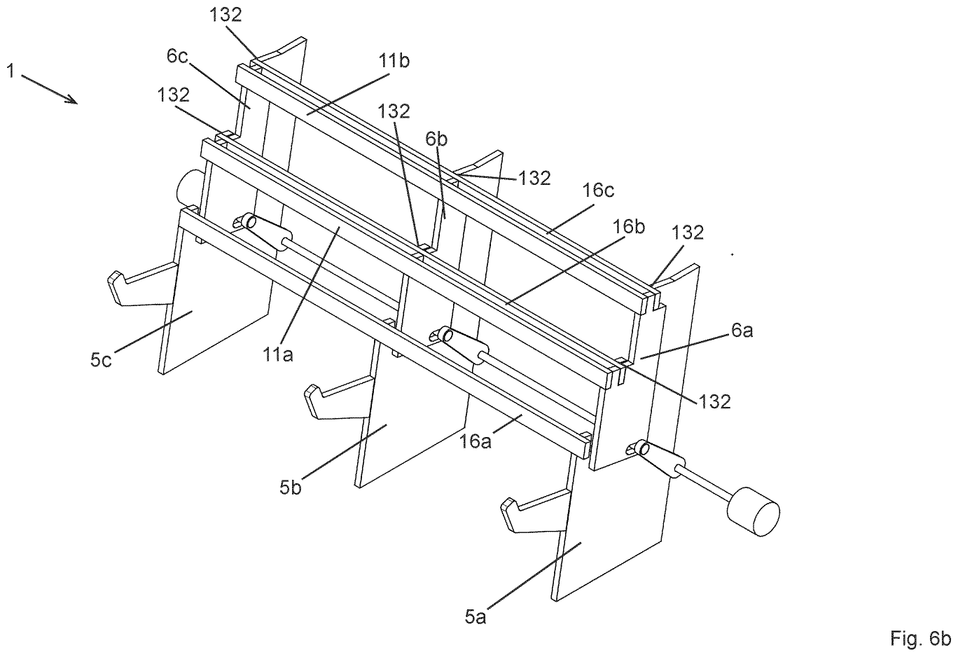

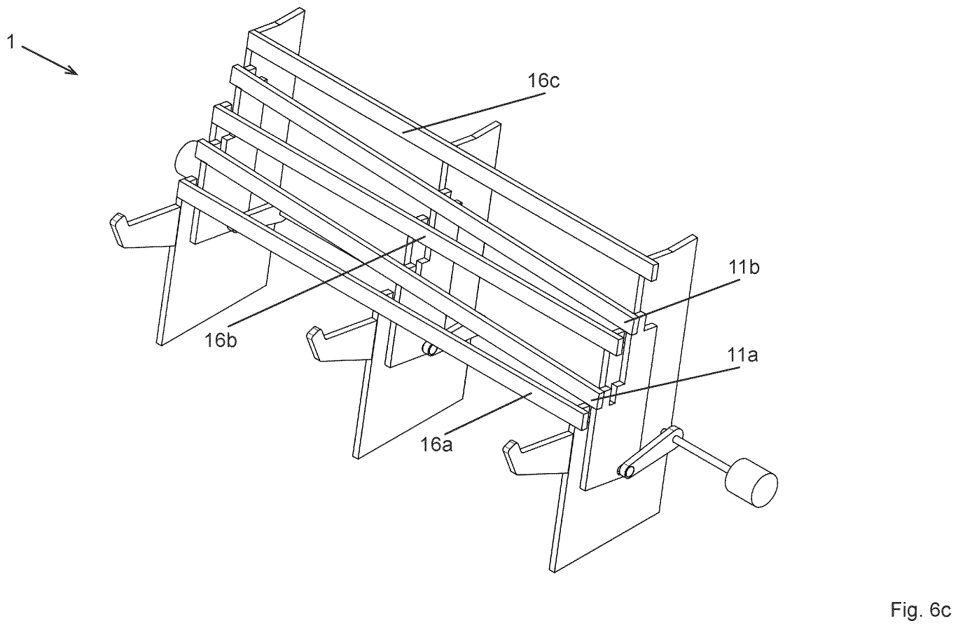

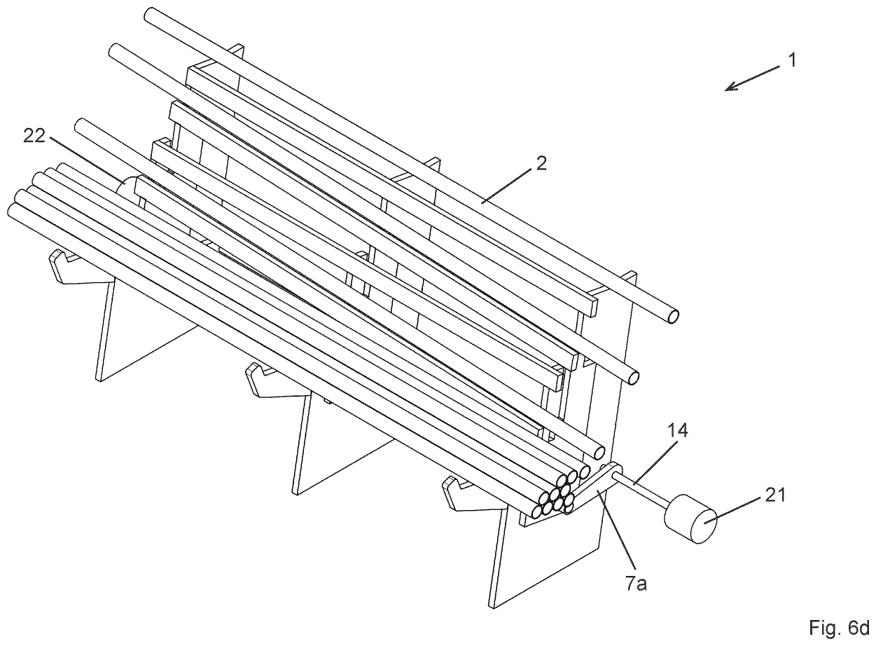

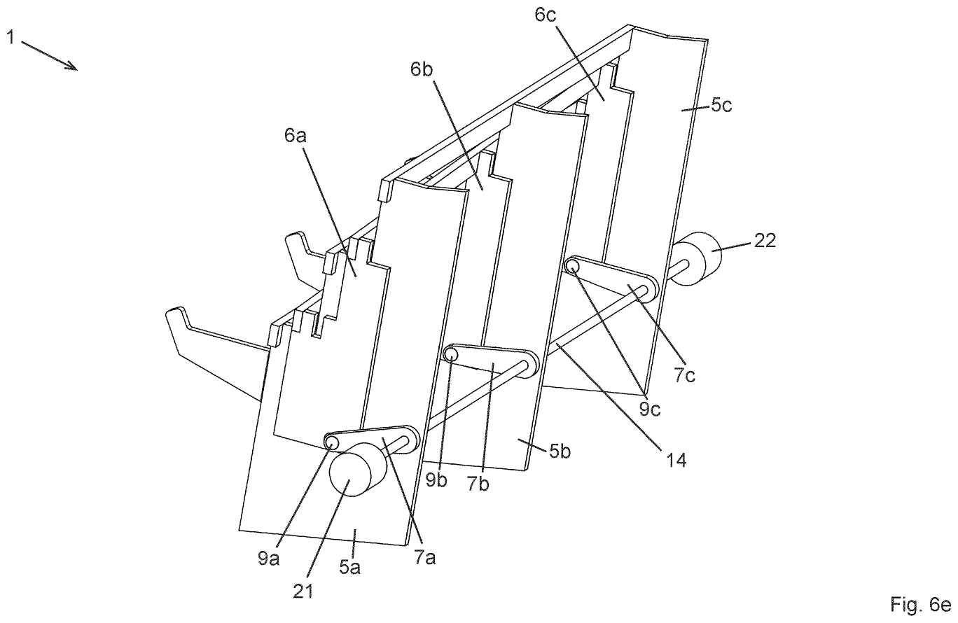

FIG. 6a-FIG. 6e Illustration of the mode of operation of a third stair conveyor according to the invention with first rails and second rails.

FIG. 1 shows a stair conveyor 1 for pre-materials in the form of tubes 2 according to the state of the art. The stair conveyor 1 has three steps 3a, 3b, 3c. FIG. 1 shows a side view of a first stair element 5a, which is stationary on the ground 4, and a second stair element 6a, which is movable up and down relative to the first stair element 5a. The second stair element 6a is movable up and down by means of a drive lever 7a, which is mounted in an elongated hole 8a by means of a pin 9a in the second stair element 6a. The steps 3a, 3b, 3c of the stair conveyor 1 are inclined from an open side to a closed side towards the ground 4, so that tubes 2 placed laterally on the open side of the step can roll down the step 3a, 3b, 3c. The stair conveyor 1 has a batch holder 10 for the tubes 2 that can be moved up and down.

The second stair element 6a is shown in a lower position in FIG. 1. FIG. 1b shows the stair conveyor 1 in FIG. 1 in the same lateral view, with the second stair element 6a shown in an upper position. The drive lever 7a is rotated approximately 70 degrees clockwise. While in the lower position in FIG. 1 a lower second tread 61a of the movable second stair element 6a forms a level tread with the lower first tread 51a of the first stair element 5a, in the upper position the lower second tread 61a of the movable second stair element 6a forms a level tread with an upper first tread 52a of the first stair element 5a. It should be noted that in FIGS. 1a and 1b, in addition to the lower tread 51a and upper tread 52a of the first stair element 5a, there is also an even higher tread 53a.

FIG. 1c shows the stair conveyor 1 in the prior art in an isometric view in the lower position, with some tubes 2 already shown in various conveying positions. The stair elements are spaced apart from each other. The first stair elements 5a, 5b, 5c are evenly spaced apart. A second stair element 6a, 6b, 6c, which is movable relative to the first stair element, is arranged directly next to each first stair element 5a, 5b, 5c. The batch holder 10 can be moved up and down independently of the second stair elements 6a, 6b, 6c.

FIGS. 2a to 2d show the basic mode of operation of the known stair conveyor 1 with only two steps 3a, 3b. The first stair element 5a, 5b, 5c has two treads 51a, 52a, 51b, 52b, 51c, 52c, while the movable second stair element 6a, 6b, 6c has only one tread 61a, 61b, 61c. Due to the inclined slope and flat design of the lower step 3a, the tubes 2 lying parallel next to each other can run against a next higher first riser 54a, 54b, 54c in FIG. 2a and there be conveyed to the higher step 3b by a uniform upward movement of the second stair elements 6a, 6b, 6c, where they roll away from the edge of the step due to the likewise inclined slope of the upper step 3b, which is formed by the upper first tread 52a, 52b, 52c and the raised second tread 61a, 61b, 61c, and can be fed for further processing. The process is shown in individual steps in FIGS. 2a to 2d.

FIGS. 3a to 3d graphically illustrate the problem of skewed tubes 2 that occurs in the prior art. The tubes 2 in FIG. 3a do not lie parallel to each other, but lie at an angle to each other on the lower steps 3a. As a result, it is possible in particular that not all of the tubes 2 are caught when the second stair elements 6a, 6b, 6c move upwards. As shown in FIGS. 3b and 3c, a right-hand section of one of the tubes 2 is already positioned in front of the right-hand second stair element 6a in the starting position in FIG. 3a and therefore cannot be lifted at all, while the left-hand and centre sections of the same tube 2 are gripped by the associated centre and left-hand second stair elements 6b, 6c and are lifted. As shown in FIG. 3c, the tube 2 then rests at an angle on different steps 3a, 3b in the upper position. Disadvantageously, the skewed tube 2 blocks the other two tubes 2 from unrolling on the upper step 3b in the upper position, thereby stopping the machining process.

FIGS. 4a to 4f show a first embodiment of the stair conveyor 1 according to the invention, with second rails 11a fixedly arranged on the movable second stair elements 6a, 6b, 6c and extending over the entire longitudinal direction L of the stair conveyor 1. The second rail 11a is rectangular in cross-section and made of aluminium or metal, although other materials can also be used. The second rail 11a is attached in the transition areas between the treads and risers of the second stair elements 6a, 6b, 6c. Preferably, the second rail 11a has a second slipping edge 12a, which extends over the entire longitudinal direction L. The length of the second rail 11a is preferably at least as long as the length of the tubes 2 to be conveyed. FIGS. 4a to 4d show a schematic view of the stair conveyor 1 in four process steps. In the lower position, as shown in FIG. 4a, a tube 2 is positioned on the lower step 3a. The tube 2 lies at an angle. For example, it could be bent in on itself or rest at an angle on the lower step 3a. During the upward movement of the second stair elements 6a, 6b, 6c, the tube 2 slips over the second slipping edge 12a of the movable second rail 11a during the upward movement of the second stair elements 6a, 6b, 6c and falls back onto the first step 3a as shown in FIG. 4c. During the downward movement of the second stair elements 6a, 6b, 6c in FIG. 4d, the tube 2 can be picked up a second time after the stair conveyor has reached the lower position. Since the position of the tube 2 is now very likely to be different than in FIG. 4a, there is an increased probability that the tube 2 will just rest on the lower tread 51a, 51b, 51c of the first stair elements 5a, 5b, 5c during the second lifting attempt and then roll or slide onto the lower second tread 61a, 61b, 61c of the second stair elements 6a, 6b, 6c in the lower position and can be lifted properly.

FIGS. 4e and 4f show the stair conveyor 1 in two isometric views, with three additional movable lifting arms of a batch holder 10 being shown. FIGS. 4a to 4d show two steps 3a and 3b, while FIGS. 4e to 4f show a third step 3c.

FIG. 4f shows the stair conveyor 1 in a lower position. The three second stair elements 6a, 6b, 6c are moved into the lower position and the two second rails 11a, 11b disappear completely into first indentations 131, which are each recessed into one of the first treads 51a, 52a, 51b, 52b, 51c, 52c of the first stair elements 5a, 5b, 5c. An upper edge of the rails 11a, 11b, the first treads 51a, 52a, 51b, 52b, 51c, 52c and the second treads 61a, 62a, 61b, 62b, 61c, 62c each form a flat tread which allows the tubes 2 to slide or roll from the open side of the treads to the closed side of the treads.

FIG. 4f shows the drive via three drive levers 7a, 7b, 7c, one end of which is firmly connected to a drive shaft 14 and the other end of which is movably mounted in a slotted hole 8a, 8b, 8c with a pin 9a, 9b, 9c in each case.

In FIG. 4e, the second stair elements 6a, 6b, 6c have already been moved up a little. The position corresponds approximately to the position in FIG. 4d.

FIGS. 5a to 5d show a second embodiment of the stair conveyor 1 according to the invention with continuous first rails 16a, which are connected in a fixed position to the first stair elements 5a, 5b, 5c. The first rail 16a is attached to the transition area between the tread and riser. For this purpose, a first recess 20 can be embedded in the transition area. However, it is also conceivable that rail pieces are fastened between lateral stringers of the first stair elements 5a, 5b, 5c. Analogue devices are of course also conceivable for the first embodiment with the second rails as well as the embodiments with both first and second rails 16a, 16b, 11a, 11b, which are still to be discussed. FIG. 5a shows the lifting of a tube 2, which in FIG. 5b comes to rest at an angle on the upper step 3b.

FIG. 5c shows the downward movement of the second stair elements 6a, 6b, 6c. The right-hand side of the tube 2 rests on the right-hand second stair element 6a and is moved downwards in a guided manner. During the downward movement, the tube 2 slips over a first slipping edge 17a of the first rail 16a and then comes to rest again on the first step 3a. It can then be lifted a second time.

FIGS. 6a to 6c show a stair conveyor 1 in a third embodiment of the invention. According to FIG. 6b, continuous first rails 16a, 16b, 16c are attached between the first stair elements 5a, 5b, 5c and continuous second rails 11a, 11b are attached between the second stair elements 6a, 6b, 6c. The stair conveyor 1 is shown in a side view in FIG. 6a. FIG. 6a shows the upper position of the second stair elements 6a, 6b, 6c.

FIG. 6b shows the stair conveyor 1 of FIG. 6a in an isometric view and without tubes 2 in place. Approximately half of the depth of a tread is formed by the depth of the first tread and approximately half by the depth of the second tread.

The second stair elements 6a, 6b, 6c have second indentations 132 on their treads, into which the first rails (16b, 16c) are embedded in the upper position. This forms a flat tread.

FIGS. 6c and 6d show a further development of the stair conveyor 1. FIG. 6c shows that the continuous second rails 11a, 11b no longer run horizontally and parallel to the continuous first rails 16a, 16b, 16c, but are inclined at an angle to the ground 4 in a position between the upper and lower positions.

FIG. 6d shows the position of FIG. 6c with tubes 2 in place. FIG. 6e shows a rear view of the stair conveyor 1 of FIG. 6c. The second stair elements 6a, 6b, 6c are driven by the drive levers 7a, 7b, 7c. The drive levers 7a, 7b, 7c are non-rotatably connected to a drive shaft 14 and extend movably in the slotted holes via the pins 9a, 9b, 9c. In contrast to the prior art, however, the drive shaft 14 has a separate drive 21, 22, preferably in the form of a motor or servomotor, at each of its outer ends. The drives 21, 22 can be controlled separately. During the lifting movement or also the lowering movement, the drives are not controlled at the same time, but are controlled offset, so that the drive shaft 14 twists. As a result, the drive levers 7a, 7b, 7c are rotated by different amounts, depending on their position along the drive shaft 14, and the associated second stair elements 6a, 6b, 6c are raised or lowered by different amounts. This results in the inclined position of the treads of the second stair elements 6a, 6b, 6c shown in FIGS. 6c and 6d and, associated with this, an inclined position of the tubes 2 lying on them. Preferably, the first and second drive 21, 22 alternately run before and after each other during successive up and down movements. The inclined position of the tubes 2, which varies depending on the lifting process, makes it easier for crooked or curved tubes 2 to slide off.

### LIST OF REFERENCE SYMBOLS

1 Stair conveyor
2 Tube
3a Step
3b Step
3c Step
4 Ground
5a First stair elements
5b First stair elements
5c First stair elements
6a Second stair elements
6 Second stair elements
6c Second stair elements
7a Drive lever
7b Drive lever
7c Drive lever
8a Elongated hole
8b Elongated hole
8c Elongated hole
9a Pin
9b Pin
9c Pin
10 Batch holder
11a Second rails
11b Second rails
12a Second slipping edge
12b Second slipping edge
14 Drive shaft
16 First rails
16th First rails
16c First rails
17a First slipping edge
17b First slipping edge
17c First slipping edge
20 Recess
21 Drive
22 Drive
51a Lower first tread
51 Lower first tread
51c Lower first tread
52a Upper first tread
52b Upper first tread
52c Upper first tread
53 Next higher first tread
53b Next higher first tread
53c Next higher first tread
54a Next higher first riser
54b Next higher first riser
54c Next higher first riser
61a Lower second tread
61b Lower second tread
61c Lower second tread
62a Upper second tread
62b Upper second tread
62c Upper second tread
131 First indentations
132 Second indentations
L Longitudinal direction

1. Stair conveyor for bar-shaped materials with
a first stair with at least two first stair elements spaced apart from each other and
a second stair movable up and down relative to the first stair between a lower position and an upper position and having at least two second stair elements spaced apart from one another, wherein
the first and second stair elements are arranged next to each other in a longitudinal direction (L), and
lower first treads of the first stair elements and lower second treads of the second stair elements co-form a lower tread in the lower position, and
upper first treads of the first stair elements and the lower second treads of the second stair elements also form an upper tread in the upper position,
wherein the first stair elements are connected to one another at transition regions between first risers and treads by first rails which form a first slipping edge for the bar-shaped materials and/or the second stair elements are connected to one another at transition regions between second risers and treads by second rails which form a second slipping edge for the bar-shaped materials.

2. Stair conveyor according to claim 1,
wherein one stroke of an up and down movement has the height of a riser.

3. Stair conveyor according to claim 1,
wherein directly adjacent transition regions of first stair elements are connected to one another by the first rails and/or directly adjacent transition regions of second stair elements are connected to one another by second rails.

4. Stair conveyor according to claim 1,
wherein first and second stair elements are arranged alternately in a longitudinal direction (L).

5. Stair conveyor according to claim 1,
wherein the adjacent transition regions between second stair elements are connected to the second rail and lower first treads each have a first indentation, the cross-section of which is larger than a cross-section of the second rail, such that the second rails disappear in the first indentations during a downward movement and form a flat lower tread in the lower position.

6. Stair conveyor according to claim 1,
wherein adjacent transition regions between first stair elements are connected to the first rail and treads of lower second stair elements each have a second indentation, the cross-section of which is larger than a cross-section of the first rail, such that the first rails disappear in the second indentations during an upward movement and forms a flat upper tread in the upper position.

7. Stair conveyor according to claim 1,
wherein the transition regions have recesses through which a continuous rail is guided, which connects several stair elements to one another.

8. Stair conveyor according to claim 1,
wherein the second stair elements are each connected to a continuous drive shaft which is connected to two drives and can be controlled by the drives in such a way that the drive shaft can be set in torsion.

9. Stair conveyor according to claim 1,
wherein the drive shaft is connected to one of the second stair elements via a respective drive lever and the drive levers are connected to the drive shaft in a rotationally fixed manner.

10. Method for conveying bar-shaped materials with a stair conveyoy according to claim 1, in that
the bar-shaped materials are lifted from a lower step onto an upper step by the upward movement of the second stair elements and bar-shaped materials slipping on one of the steps slide off independently over one of the slipping edges.

11. Method according to claim 10,
wherein on the upper step, inclined bar-shaped materials slide over the first sliding edge during the downward movement of the second stair elements.

12. Method according to claim 10,
wherein on the lower step, inclined bar-shaped materials slide down over the second slipping edge during the upward movement of the second stair elements.

13. Method according to claim 10,
wherein the second stair elements are moved offset relative to one another during the relative movement.

14. Method according to claim 10,
wherein the first drive and the second drive start in the same initial position and the first drive runs ahead of the second drive and in an end position the two drives run in the same direction again.
